(19) United States
(12) Patent Application Publication
(10) Pub. No.: US 2006/0069812 A1
(43) Pub. Date: Mar. 30, 2006

(54) Method to mitigate performance turnaround in a bidirectional interconnect

(76) Inventor: Randy B. Osborne, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/954,462

(22) Filed: Sep. 30, 2004

(51) Int. Cl. G06F 3/00

(52) U.S. Cl. 710/5

(57) ABSTRACT

A memory controller is disclosed. The memory controller includes a mechanism to perform a first command to transition an interface coupled between the memory controller and to facilitate a memory write and to perform a second command to immediately write data to the memory device a predetermined period after performing the command to transition the interface.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to computer systems; more particularly, the present invention relates to controlling memory devices.

### BACKGROUND

A bidirectional interface is a pin-efficient mechanism implemented for connecting to memory devices, such as DRAMs. However, bandwidth efficiency suffers from the loss of bandwidth during the idle periods required to turn the interconnect around. Such turnarounds occur between writes and reads and between reads and writes, as the interconnect transmitter and receiver exchange roles.

Moreover, as the data rate on bidirectional interconnects scales to achieve performance requirements of future memory systems, the turnaround time will only slowly change, being more a function of the propagation latency of the channel than of the speed of the logic on either end of the interconnect. Thus these turnarounds will cause a larger and larger proportion of lost bandwidth as the data rate scales.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates one embodiment of a timing diagram for an opportunistic write;

FIG. 3 illustrates one embodiment of a flow diagram for the implementation of turnaround and immediate write commands;

FIG. 4 illustrates one embodiment of a timing diagram for turnaround and immediate write commands; and

FIG. 5 illustrates another embodiment of a timing diagram for turnaround and immediate write commands.

### DETAILED DESCRIPTION

According to one embodiment, a method to mitigate performance turnaround in a bidirectional interconnect is described. In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

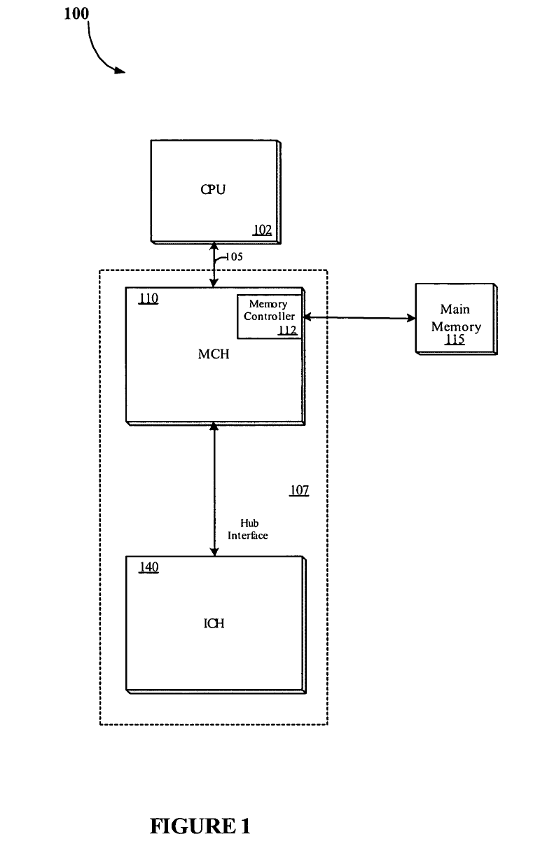

FIG. 1 is a block diagram of one embodiment of a computer system 100. Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to bus 105, such as multiple CPUs and/or multiple system memories.

Chipset 107 also includes an input/output control hub (ICH) 140 coupled to MCH 110 to via a hub interface. ICH 140 provides an interface to input/output (I/O) devices within computer system 100. For instance, ICH 140 may be coupled to a Peripheral Component Interconnect bus adhering to a Specification Revision 2.1 bus developed by the PCI Special Interest Group of Portland, Oreg.

As discussed above, memory controller 112 interfaces with main system memory 115. In one embodiment, memory controller 112 is coupled to memory 115 via a bidirectional interface. As previously mentioned, idle periods are incurred while turning the interconnect around. As a result, write flushes are often executed by queuing a multitude of write commands at memory controller 112 and transmitting the writes to memory 115 the writes as a batch.

In some instances, however, it would be inefficient to queue write commands if the interface is not being used. Therefore, memory controllers typically feature an opportunistic write command that performs a single write command if the interface is not being used. However, a problem may occur during the implementation of a write command where a read command is received immediately after initiating the opportunistic write command.

The problem is that the read command cannot be serviced until after the write command has been completed. Before the command can be completed, however, the interface is first turned around to permit the write command, and subsequently the write command is performed. This leads to a relatively long delay prior being able to issue the read command.

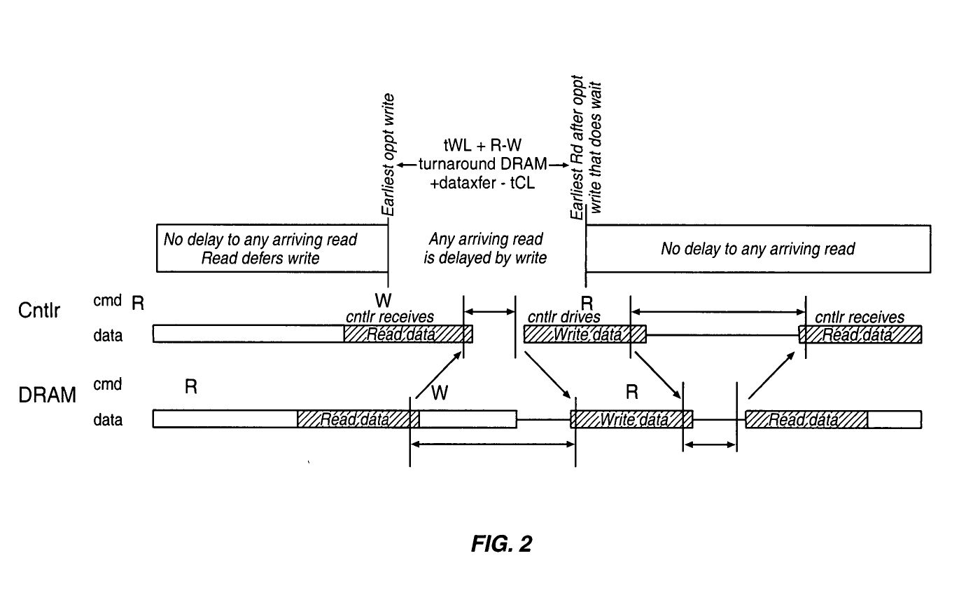

FIG. 2 illustrates one embodiment of a timing diagram for an opportunistic write. FIG. 2 shows intervals to the right and left that indicate periods for which no delay is incurred upon receiving a read command. However, the middle interval indicates a delay incurred for a read received at a certain time after the opportunistic write has been initiated.

According to one embodiment, memory controller 112 performs two new commands to implement a write. The first command is a turnaround command (TRW) that begins a read-write turnaround in preparation for a write. In one embodiment, the TRW command specifies a target rank and bank set. The second command is an immediate write command (IW).

According to one embodiment, the IW command is similar to a write column address signal (Wr CAS) with short write latency (tWL) (e.g., includes CAS address). In a further embodiment, data is posted into memory 115 and transferred to a memory 115 array in one column access. Thus the IW command is not sensitive to tWL.

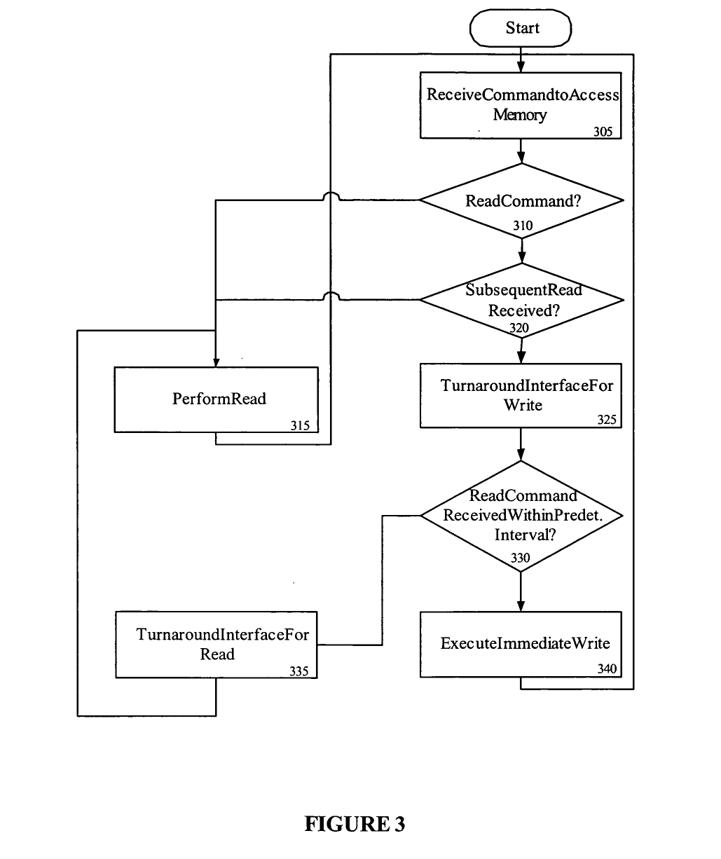

FIG. 3 illustrates one embodiment of a flow diagram for the implementation of turnaround and immediate write commands. At processing block 305, a command to access memory 115 is received at memory controller 112. At decision block 310, it is determined whether the command is a read command. If the command is a read command, the read is performed and data is read from memory 115 via the interface, processing block 315.

However, if the command is a write command it is determined whether a read command has recently been received, decision block 320. If a read command has been received control is returned to processing block 315 where the read is performed. If, however, no read command has been received, memory controller 112 performs the TWL command, and the interface is turned around so that a write command may be performed, processing block 325.

At decision block 330, it is determined whether a read command has been received within a predetermined period since the TWL command has been performed. If a read command has been received, the interface is turned back around so that the read may be performed, processing block 335. Subsequently, control is returned to processing block 315 where the read is performed. If no read command has been received, memory controller 112 performs the IW command, and an immediate write is performed, processing block 340.

The TRW and IW commands permit an opportunistic write to be separated into two decision points (e.g., turnaround and data transfer). As a result, each decision point may now be delayed until as late as possible. Thus if a read arrives after the turnaround decision but before data the transfer decision, the data transfer can be aborted, reducing the delay to the read. The opportunistic write data transfer can be re-scheduled for a subsequent time.

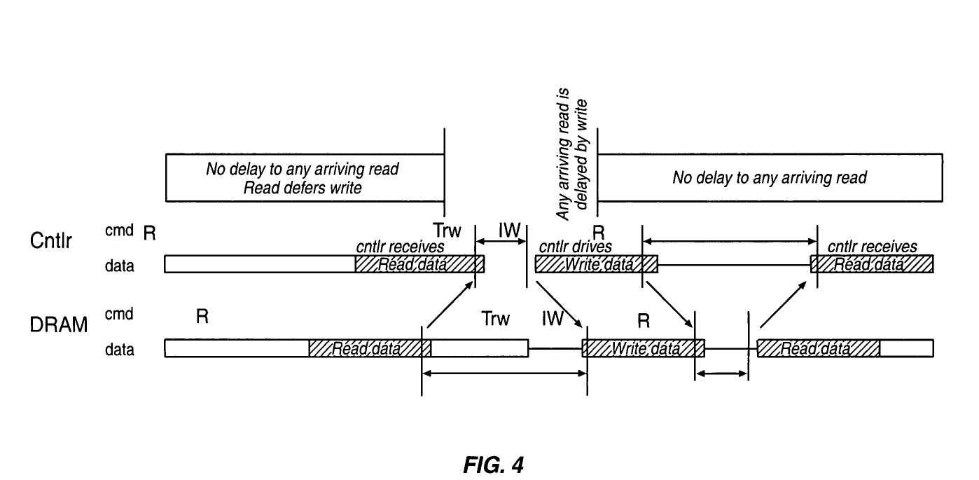

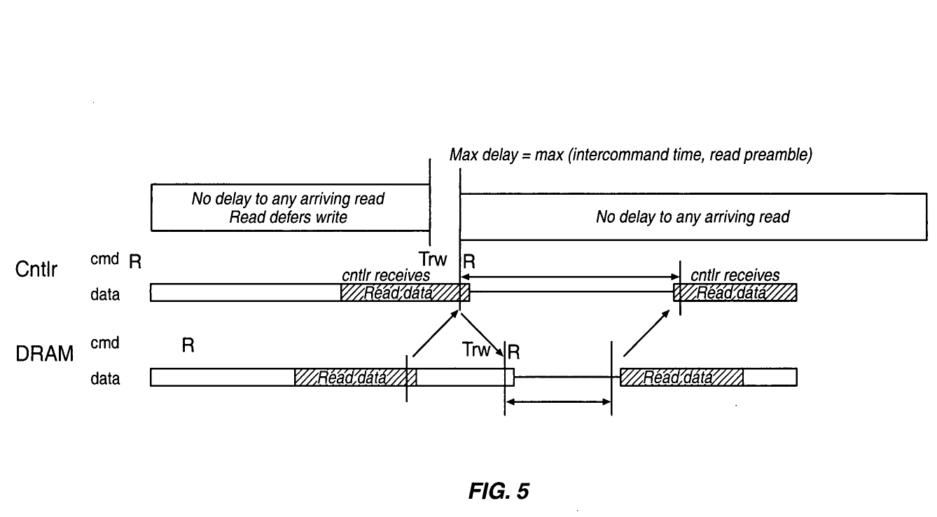

FIGS. 4 and 5 illustrate how separating the write commands into two new commands permits the turnaround penalty to be minimized. FIG. 4 illustrates one embodiment of a timing diagram where a read is received after the IW command. In this instance, the delay period is reduced to the amount of time to perform the IW command, since no read command would have been received after the TRW command and before the issuance of the IW command.

FIG. 4 illustrates one embodiment of a timing diagram where a read is received after the TRW command, but before the IW command. As shown in FIG. 5, only a small delay period is incurred because only the interface is turned around prior to beginning the write.

The above described method enables the turnaround penalty to be significantly reduced since either no read traffic to be penalized for read-write turnaround, or a write can be aborted to minimize latency for a newly arriving read. Thus, there is a latency savings approximately equal to the write data transfer time plus time to turn the interface around at the memory.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. A method comprising:
receiving a write command at a memory controller to write to a memory device;
performing a command to turnaround an interface between the memory controller and the memory device in order to facilitate a memory write; and
performing a command to immediately write data to the memory device at least a predetermined minimum period after performing the command to turnaround the interface.

2. The method of claim 1 further comprising:
determining whether a read command has been received at the memory controller within an interval between the command to turnaround the interface and the command to immediately write data after the interface has been turned around; and
transitioning the interface in order to facilitate a memory read.

3. The method of claim 2 further comprising reading data from the memory device.

4. The method of claim 1 further comprising:
determining whether a read command has been received at the memory controller after receiving the write command; and
reading data from the memory device.

5. The method of claim 1 further comprising writing data to the memory device.

6. A computer system comprising:
a main memory device;
a bi-directional interface coupled to the main memory device; and
a memory controller, coupled to the bi-directional interface, to perform a first command to turnaround the interface to facilitate a memory write and to perform a second command to immediately write data to the memory device at least a predetermined period after performing the command to turnaround the interface.

7. The computer system of claim 6 wherein the memory controller further turns around the interface and delays the write in order to facilitate a memory read if a read command is received within the predetermined period after the interface turns around to facilitate the write.

8. The computer system of claim 6 wherein the first command specifies a target rank and bank set of the memory device.

9. (canceled)

10. The memory controller of claim 98 wherein the second command is similar to a write column address signal with short write latency.

11. A memory controller comprising a mechanism to perform a first command to turnaround an interface coupled between the memory controller and to facilitate a memory write and to perform a second command to immediately write data to the memory device a predetermined period after performing the command to turnaround the interface.

12. The memory controller of claim 11 wherein the mechanism causes the memory controller to turnaround the interface in order to facilitate a memory read if a read command is received within an interval between the command to turnaround the interface and the command to immediately write data after the interface turns around to facilitate the write.

13. The memory controller of claim 11 wherein the first command specifies a target rank and a set of banks within of the memory device.

14. The memory controller of claim 11 wherein the second command causes data to be posted into the memory device and transferred to an array in one column access.

15. The memory controller of claim 11 wherein the second command is similar to a write column address signal with short write latency.

16. An article of manufacture including one or more computer readable media that embody a program of instructions, wherein the program of instructions, when executed by a processing unit, causes the processing unit to:
receive a write command at a memory controller to write to a DRAM;
perform a command to transition an interface between the memory controller and the DRAM in order to facilitate a memory write; and
perform a command to immediately write data to the DRAM at least a predetermined period after performing the command to transition the interface.

17. The article of manufacture of claim 16 wherein the program of instructions, when executed by a processing unit, further causes the processing unit to:
determine whether a read command has been received at the memory controller within the predetermined period after the interface transitioning; and
transition the interface in order to facilitate a memory read.

18. The article of manufacture of claim 17 wherein the predetermined period is an interval between the command to transition the interface and until the memory controller issues the command to write data.

19. The article of manufacture of claim 17 wherein the program of instructions, when executed by a processing unit, further causes the processing unit to read data from the DRAM.

20. The article of manufacture of claim 16 wherein the program of instructions, when executed by a processing unit, further causes the processing unit to:
determine whether a read command has been received at the memory controller after receiving the write command; and
read data from the DRAM.

21. The article of manufacture of claim 16 wherein the program of instructions, when executed by a processing unit, further causes the processing unit to write data to the DRAM.
